(19) United States
(12) Patent Application Publication
(10) Pub. No.: US 2008/0151545 A1
(43) Pub. Date: Jun. 26, 2008

(54) Decorative lighting display with changeable shades and bulbs

(76) Inventor: Edward Kratz, San Jancinto, CA (US)

Correspondence Address: THE INVENTORS NETWORK, INC., 332 ACADEMY STREET, CARNEGIE, PA, 15106, US

(21) Appl. No.: 11/645,333

(22) Filed: Dec. 26, 2006

(51) Int. Cl. F21V 21/00

(52) U.S. Cl. 362/249

(57) ABSTRACT

An outdoor decorative lighting arrangement and system includes a plurality of lighting fixtures disposed about a walkway or driveway, and each lighting fixture including a stake, a bulb and shade assembly, and a coupling configuration providing for the attachment and detachment of the bulb and shade assembly to the stake. The shades are also detachable and interchangeable on the lighting fixtures and come in a variety of forms or shapes representing various events, seasons, and holidays, and the shades can incorporate solar panels as the energy source that illuminates the bulbs. The stakes and the bulb and shade assemblies also include quick connect/disconnect interior plugs, and the entire decorative lighting arrangement can be powered from standard 110-volt AC current, 12-volt DC current, by a rechargeable battery, or from roof mounted solar panels connected to a battery with the battery then providing the direct current to the lighting system for illuminating the bulbs.

### FIELD OF THE INVENTION

The present invention pertains to decorative outdoor lighting arrangements, and more particularly pertains to an outdoor lighting system that includes changeable decorative shades and bulbs, and several different power sources.

### BACKGROUND OF THE INVENTION

In order to enhance the appearance of residential and commercial properties and dwellings, decorative lighting arrangements are commonly used to outline and illuminate the walkways, flower gardens, sidewalks and driveways of the properties. The lighting arrangements are generally of low intensity and the various types of lights or bulbs comprising the arrangement are mounted upon stakes that are fixed into the ground at regularly spaced intervals for outlining and illuminating the walkways, sidewalks, and driveways. Thus, the lighting arrangement has a practical aspect in that it is easier and safer to traverse illuminated walkways, sidewalks, and driveways at night, especially for young children and the elderly. In addition, the shades or covers for the bulbs can come in various shapes, forms and designs that represent or correspond to particular events or holidays such as Halloween, Thanksgiving, Hanukkah, President's Day, the Fourth of July, Christmas, Easter, Passover, the Eid, etc. The shades or covers can be detachable so that one only needs to change the shades so that the lighting arrangement corresponds to the particular holiday while leaving the rest of the lighting arrangement infixed in the ground. The stakes or posts that support the shades or covers can be of various materials such as wood, plastic, copper, brass or iron, and do not generally require tools for insertion into the ground. In many cases such decorative lighting arrangements are permanently infixed in the ground and are thus considered fixtures of the dwelling.

Because of their widespread use as both practical safety additions for a dwelling and their ability to aesthetically enhance a residence or commercial establishment, the prior art discloses a number of designs and arrangements for decorative lighting systems.

For example, the Altman patent (U.S. Pat. No. 5,274,537) discloses a decorative component in the form of a cover that can be substituted for standard commercial illuminated markers.

The Carter patent (U.S. Pat. No. 5,586,742) discloses a light standard that includes a flange for securement to the ground, a post, and a plastic cap for covering the top of the post.

The Whittington patent (U.S. Pat. No. 5,954,426) discloses an interchangeable lamp that includes several tubes of different lengths, each of which is securable to a base for varying the vertical location of the light source.

The Murray patent (U.S. Pat. No. 6,000,820) discloses a low voltage light novelty decoration that includes a novelty decoration that is interconnected to a light fixture by a continuous ring and a cone-shaped cap.

The Gilbert et al. design patent (U.S. design Pat. No. 418,935) discloses a landscape light in the shape of a novelty pumpkin head attached to a stake having a lower pointed end that is driven into the ground.

The Kratz patent (U.S. Pat. No. 6,966,680 B2) discloses a decorative lighting arrangement that includes detachable and interchangeable shades or covers with the shades or covers representative of various seasonal and holiday events and occasions.

Among the disadvantages to previous inventions is the cost and continuous maintenance involved with a previously installed outdoor lighting system. Many homeowners neither have nor desire a permanent low intensity lighting system. In addition, these devices require both the disassembly and removal of the existing light covers and they require the assembly of covers over each existing light fixture and then their removal at the end of that particular display period. Therefore, what is desired is a simple, inexpensive and complete decorative lighting display system that can be used by any homeowner with the minimum of tools and technical expertise. Such a system could be used either as a stand alone, temporary decorative lighting system, or the system could be used in conjunction with existing lighting systems through the use of regular adapters and rechargeable batteries connected to appropriately mounted and positioned solar panels.

### SUMMARY OF THE INVENTION

The present invention comprehends a decorative lighting arrangement that in one embodiment can be used with an existing low-intensity outdoor lighting system. The decorative lighting arrangement includes translucent decorative shades or covers for replacing the shades or covers of the existing low intensity outdoor lighting system.

In another embodiment the present invention comprehends an outdoor decorative lighting arrangement including a plurality of light fixtures with each light fixture including a stake, a light bulb assembly wherein the bulb and the shade are a one-piece unit, and the shade is of a translucent decorative design. In addition, the bulb and the shade may each be separate pieces or elements that are attachable in any conventional manner. The bulb and shade assembly is attachable to the stake by a coupler having a four-tab configuration. The lighting fixtures are wired together in series by a common electric wire supplying low voltage 110 volt AC current from a standard electrical wall outlet. In addition, the decorative lighting arrangement can operate off of 12 volt DC current through a transformer.

Moreover, to enhance the ease and quickness of interchangeability of the bulb and shade assembly, the plug at the end of the wire extending upwardly through the stake and the plug projecting from the bottom of the base of the stem are configured with a quick connect-disconnect capability. The plugs can also include locking and releasing members to assure that the electrical connection to the bulb and shade assembly isn't interrupted or broken by a strong wind or rainstorm tipping or dislodging the bulb and shade assembly from attachment to the stake. The outdoor decorative lighting system can be powered from a stand-alone battery that can be recharged as needed by connection to a standard battery recharging unit, or the outdoor decorative lighting system can be solar powered by roof or ground-mounted solar panels connected to a battery with the battery then delivering direct current to the serially connected light fixtures.

It is an objective of the present invention to provide an outdoor decorative lighting arrangement that provides for changeable decorative shades or covers that signify or represent various holidays, events and occasions.

It is another objective of the present invention to provide a decorative lighting arrangement that can be incorporated with an existing outdoor decorative lighting system.

Still another objective of the present invention is to provide a decorative lighting arrangement that can be easily and quickly set up with a minimum of tools and technical expertise.

Yet another objective of the present invention is to provide a decorative lighting arrangement wherein the shades and bulbs are integral one-piece units that allow for quick and easy interchange on the stakes of the lighting fixtures.

Still a further objective of the present invention is to provide a decorative lighting arrangement wherein the shades and the bulbs are separate pieces or elements, and which are easily attachable and detachable in any conventional manner.

Still yet another objective of the present invention is to provide a decorative lighting arrangement wherein the shades or covers incorporate solar panels as the electrical power source.

Yet a further objective of the present invention is to provide a decorative lighting arrangement wherein the coupling mechanism between the stakes and the bulb and shade assembly is watertight to prevent corrosion and the short-circuiting of the particular lighting fixture or the entire decorative lighting arrangement.

Yet still a further objective of the present invention is to provide a decorative lighting arrangement that can be powered by a rechargeable battery or by roof or ground-mounted solar panels connected to a rechargeable battery that, in turn, is electrically connected to the decorative lighting arrangement.

These and other objects, features, and advantages will become apparent to those skilled in the art upon a perusal of the following detailed description read in conjunction with the accompanying drawings and appended claims.

### DETAILED DESCRIPTION OF THE PREFERRED EMBODIMENTS

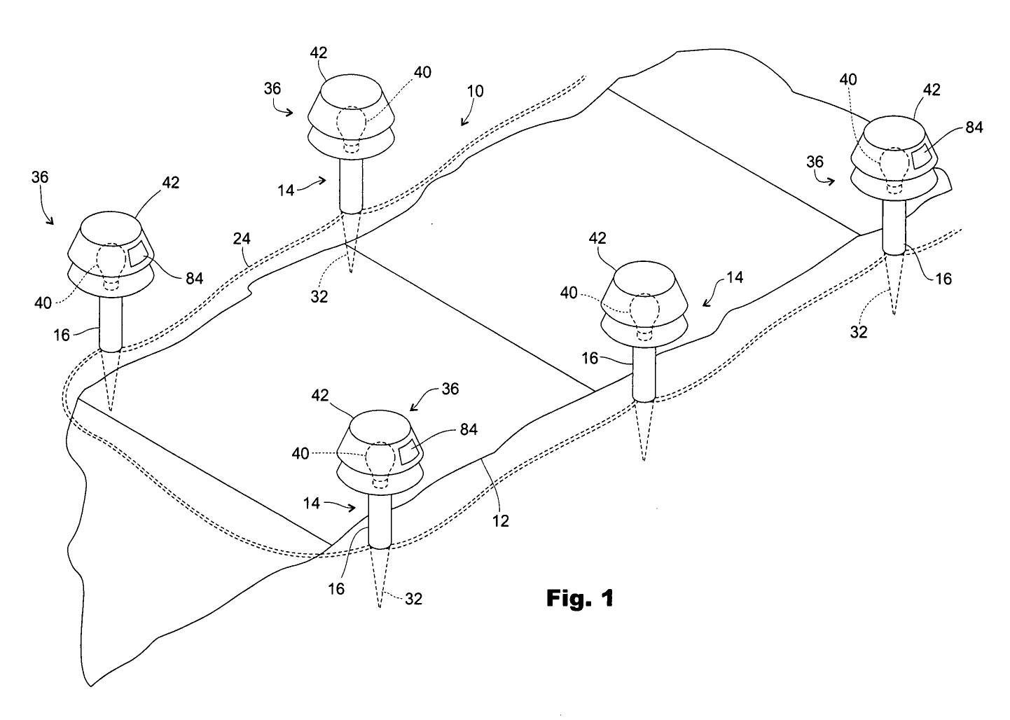

FIG. 1 is a perspective view of the decorative lighting arrangement of the present invention illustrating the disposition of the light fixtures adjacent and about a sidewalk with the decorative lighting arrangement including standard shades;

FIG. 2 is a side elevational view of the decorative lighting arrangement of the present invention illustrating the alignment of the stem of the bulb and shade assembly with the stake prior to connection, and the quick connect/disconnect plugs at, respectively, the base of the stem and the end of the electrical wire extending up through the stake;

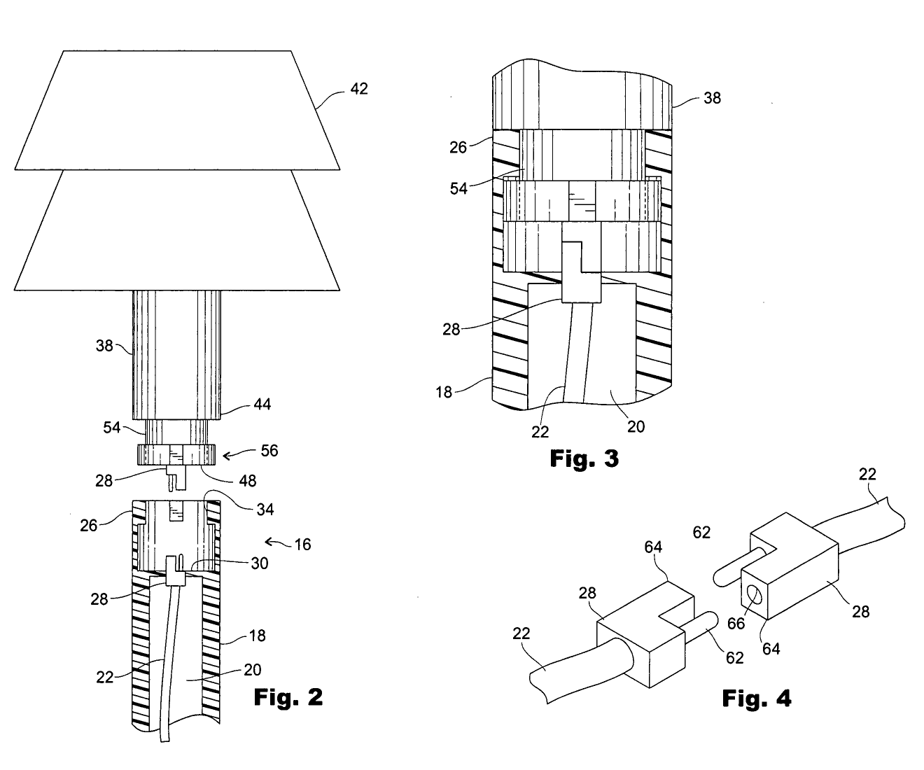

FIG. 3 is an enlarged elevational view of the decorative lighting arrangement of the present invention illustrating the securement of the bulb and shade assembly to the stake and the mating engagement of the quick connect/disconnect plugs;

FIG. 4 is a perspective view of the decorative lighting arrangement of the present invention illustrating the quick connect/disconnect plugs;

FIG. 5 is a side elevational view of the decorative lighting arrangement of the present invention illustrating an alternative configuration for the quick connect/disconnect plugs with each plug including a locking and releasing member;

FIG. 6 is an enlarged elevational view of the decorative lighting arrangement of the present invention illustrating the securement of the bulb and shade assembly to the stake and the mating engagement of the quick connect/disconnect plugs and the locking engagement of the locking and releasing members;

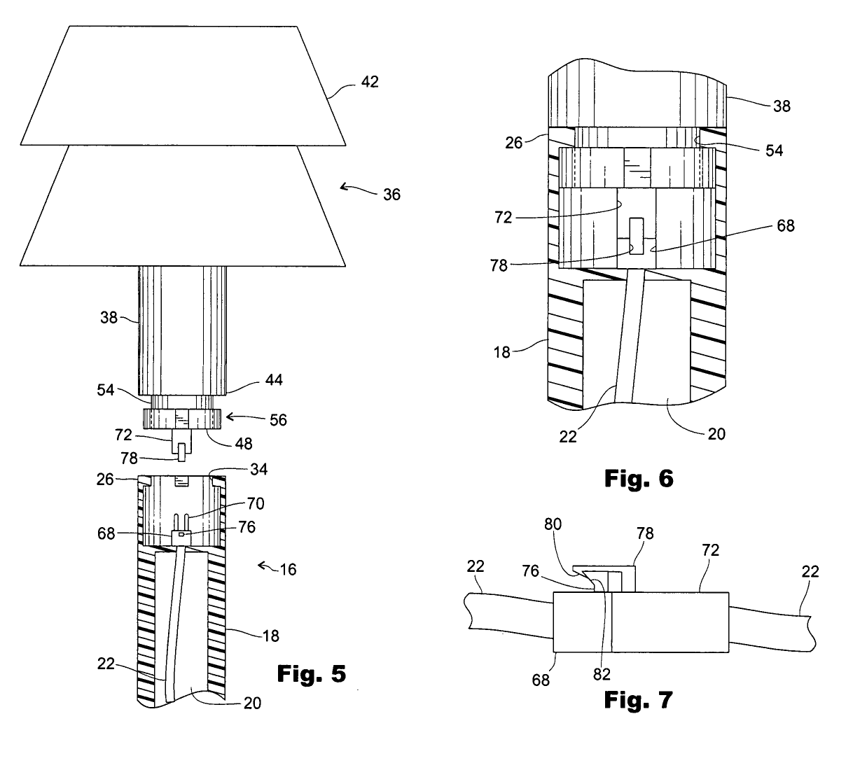

FIG. 7 is a side elevational view of the decorative lighting arrangement of the present invention illustrating the connection of the quick connect/disconnect plugs and the locking engagement of the locking and releasing members.

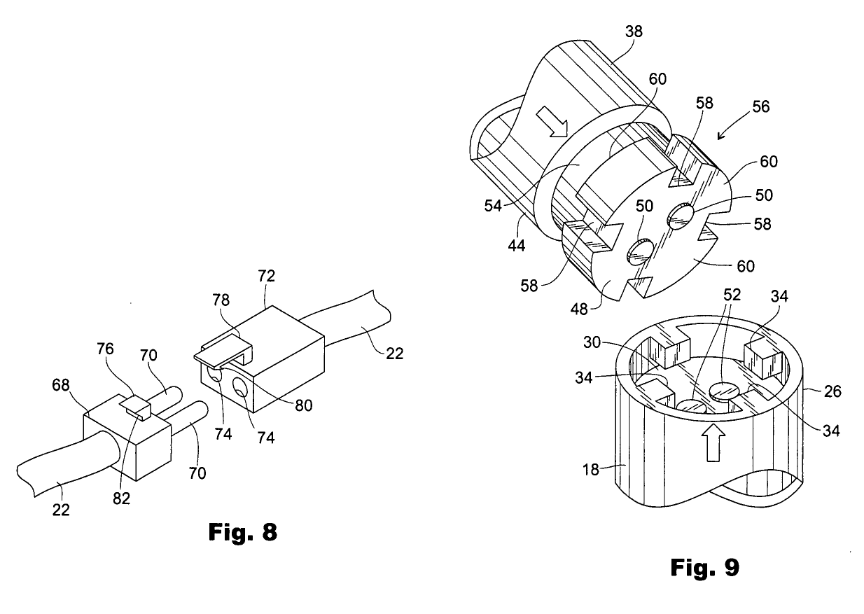

FIG. 8 is a perspective view of the decorative lighting arrangement of the present invention illustrating the alignment of the quick connect/disconnect plugs prior to their interconnection;

FIG. 9 is a perspective view of the decorative lighting arrangement of the present invention illustrating the four-tab configuration that facilitates the connection of the bulb and shade assembly to the upper end of the stake;

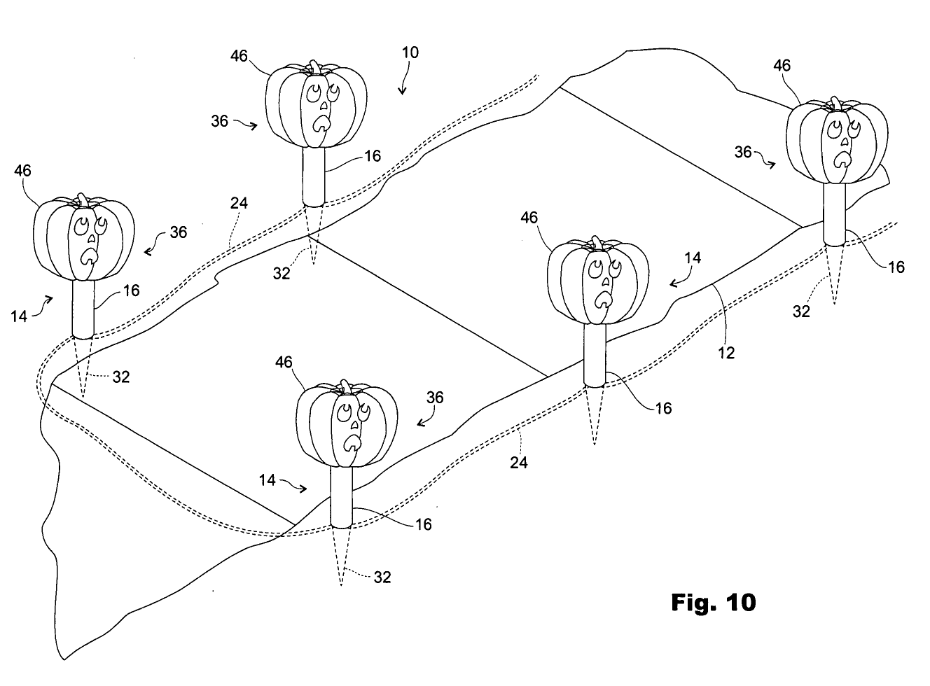

FIG. 10 is a perspective view of the decorative lighting arrangement of the present invention illustrating the use of shades that simulate the decorative form of Halloween pumpkins;

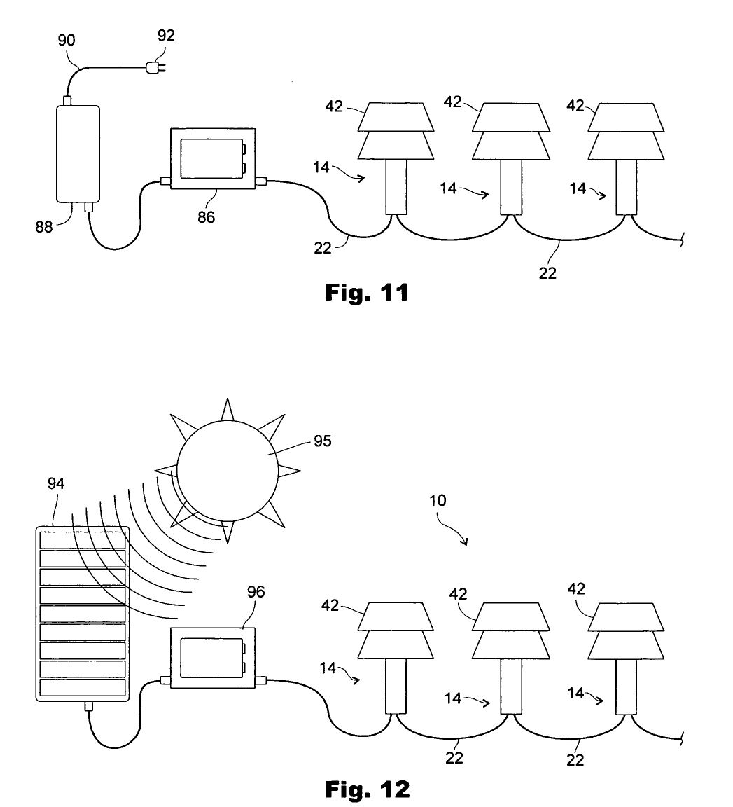

FIG. 11 is a schematic view of the decorative lighting arrangement of the present invention illustrating the use of a battery recharging unit and a battery for providing electrical power to the lighting fixtures so that the lighting fixtures can be illuminated; and

FIG. 12 is a schematic view of the decorative lighting arrangement of the present invention illustrating the use of solar panels connected to a battery for providing electrical power to the lighting fixtures so that the lighting fixtures can be illuminated.

### DETAILED DESCRIPTION OF THE PREFERRED EMBODIMENT

Illustrated in FIGS. 1-12 are various embodiments for a permanent and portable decorative outdoor lighting arrangement and system of the present invention. A first embodiment is shown in FIGS. 1-10, and includes an outdoor decorative lighting system 10 located adjacent and on either side of a driveway, sidewalk or, as shown in FIG. 1, a walkway 12 for illuminating the walkway 12 at dusk and throughout the night. The lighting system 10 includes a plurality of lighting fixtures 14 that includes a plurality of stakes or posts 16 that are capable of removable insertion into a ground surface in generally spaced-apart relationship to each other. Each stake 16 includes a continuous outer sidewall 18 (which is preferably cylindrical-shaped and tapered), and the outer sidewall 18 further defines a hollow interior 20 for enclosing and protecting electrical conductors 22 that extend up through each stake 16. The entire lighting system 10 is electrically linked and interconnected in series by a primary conductor or wiring 24 that terminates at one end with a standard plug (not shown) that plugs into an outdoor or indoor wall outlet or receptacle for providing power to the lighting system 10. The primary conductor 24 thus ties into a 60-hertz, 110-volt AC power source or a 12-volt DC power source. Since the lighting system 10 shown in FIGS. 1-10 represents a permanent installation, the primary conductor 24 that electrically connects the lighting fixtures 14 would be buried in the ground for safety and protection.

As shown in FIGS. 1-9, each stake 16 includes a cylindrical upper end 26 where the interior electrical conductor 22 terminates at a quick connect/disconnect plug 28 positioned within a recess 30 that is defined by the upper end 26 of each stake 16. The stakes 16 also includes an opposite lower tapered end 32 that facilitates the manual insertion of the lighting fixture 14 into the ground. As shown most distinctly in FIGS. 2, 3, 5, 6 and 9, located at the upper end 26 of each stake 16 is a coupling assembly or configuration that includes inwardly projecting protrusions 34. The upper end 26 of each stake 16 preferably includes four protrusions 34 that are spaced 90 degrees from each other.

The coupling assembly or configuration that includes the protrusions 34 is designed to allow for the easy and quick attachment, detachment and interchangeability of the decorative bulb and shade assemblies, and a representative decorative bulb and shade assembly 36 is shown in FIGS. 1, 2, 5, 11 and 12. The bulb and shade assembly 36 includes a stem 38, a bulb 40 and a detachable and interchangeable shade or cover 42. The base 44 of the stem 38 is configured for mating and locking engagement and disengagement with the protrusions 34 at the upper end 26 of the stakes 16. The shades or covers 42 are attachable and detachable to the stem 38 so as to provide for their interchangeability for representing and corresponding to a particular season, occasion or holiday such as, for example, Halloween, Easter, Thanksgiving, Christmas, Hanukkah, the Fourth of July, the festival of Eid, etc. In fact, the shades 42 can be shaped or formed to simulate, represent or correspond to any conceivable holiday, occasion, or event. The shades 42 shown in FIGS. 1, 2, 5, 11 and 12 are generic shades while the shades 46 shown in FIG. 10 are the more decorative shades representing a Halloween theme and simulating Jack'O Lanterns.

The light fixtures 14 include several different configurations for establishing the electrical connection from the electrical conductors 22 to the bulb 40. Thus, FIG. 9 illustrates the base 44 of the stem 38 wherein the base 44 includes a flat underside 48 that is brought into engagement with the recess 30 located at the upper end 26 of the respective stake 16. Electrical contacts 50 for the bulb 40 are located on the underside 48 of the base 44 and are brought into electrical contact with contacts 52 within located within the recess 30 when the base 44 is seated in locking engagement to the upper end 26 of the stake 16. In addition, an annular neck 54 that has a smaller diameter than the stem 38 further defines the base 44 of the stem 38. The annular neck 54 is inboard of the base 44 of the stem 38. The base 44 terminates with an enlarged circular head 56 having four spaced-apart slots or grooves 58 that are shaped to receive and allow passage therethrough of the protrusions 34. The grooves 58 are spaced or separated from each other by semi-circular ledges 60 that project outwardly from the enlarged circular head 56. The annular neck 54, enlarged circular-shaped head 56, the grooves 58, and the semi-circular ledges 60 are the structural elements of the stem 38 that form part of the aforementioned coupling assembly and configuration. The each slot 58 on the enlarged head 56 at the base 44 of the stem 38 functions similar to a mortise, and each protrusion 34 at the upper end 26 of each stake 16 functions similar to a tenon in so far as the enlarged circular head 56 is aligned with the upper end 26 of the stake 16 so that the slots 58 can pass downwardly—or upwardly for separating and detaching the bulb and shade assembly 36—through the protrusions 34. Passing the slots 58 through the respective protrusions 34 seats the base 40 of the stem 38 of the bulb and shade assembly 36 within the recess 30 of the stake 16. In the embodiment shown in FIG. 9, this seating of the base 44 of the stem 38 within the recess 30 brings electrical contacts 50 on the base 44 in contact with the contacts 52 located within recess 30. The protrusions 34 jut toward the annular neck 54 of the base 44. In order to lock the stem 38 (and thus the bulb and shade assembly 36) to the upper end 26 of the stake 16 the individual rotates the stem 38 by 90 degrees, (either clockwise or counterclockwise) thus positioning each ledge 60 under each respective protrusion 34 thereby locking the stem 38 to the upper end 26 of the stake 16, and firmly attaching the bulb and shade assembly 36 to the stake 16. To unlock the bulb and shade assembly 36 from the stake 16, the individual would first give the stem 38 a quarter turn to align the slots 58 on the enlarged circular head 56 of the stem 38 with protrusions 34. The individual would then simply lift the stem 38 straight up causing the slots 58 to pass by the protrusions 34 thus separating and detaching the bulb and shade assembly 36 from the respective stake 16. FIG. 2 can be interpreted as showing the bulb and shade assembly 36 detached from the upper end 26 of the stake 16, or, conversely, being aligned with the upper end 26 just prior to being locked to the stake 16.

Illustrated in FIGS. 2-4 is one preferred embodiment for the quick connect/disconnect plug 28 that is attached to the interior end of electrical conductor 22. The plug 28 projects into the recess 30 at the upper end 26 of stake 16. The plug 28 includes a male prong 62 and an adjacent female receiving portion 64 that includes a contact aperture 66. A second and identical plug 28 is mounted to the underside 48 of the base 44 of the stem 38 and when the stem 38 is locked to the upper end 26 of the stake 16 as aforedescribed the respective male prongs 62 and female receiving portions 64 are brought into contact thereby connecting the plugs 28 and completely the electrical circuit to the bulb 40 so that electrical power from an aforedescribed source can be provided to the bulb 40. The portion of the electrical conductor 22 extending within the interior 20 of the stake 16 will have some slack to allow for some movement and adjustment of the plug 28 at the end of the conductor 22 thereby allowing an individual to check to make sure the plugs 28 have made a tight connection to each other with the plug 28 then being seated within the recess 30.

Illustrated in FIGS. 5-8 is a second preferred embodiment for the quick connect/disconnect plugs 28 shown in FIGS. 2-4. The quick connect/disconnect plug of FIGS. 5-8 includes a male plug 68 attached to the interior end of the electrical conductor 22, and the male plug 68 includes a pair of male prongs 70. A female plug 72 is mounted to the base 44 of the stem 38 and projects downwardly therefrom. The female plug 72 includes a pair of receiving apertures 74 that receive the male prongs 70 so that the electrical connection to the bulb 40 can be made. The portion of the electrical conductor 22 extending through the hollow interior 20 of the stake 16 has some slack so that the individual can ascertain that the male and female plugs 68 and 70 are securely attached. In addition, the male and female plugs 68 and 70 include locking and releasing structures or members to assure their attachment to each other. Thus, the male plug 68 includes a locking tab 76 and the female plug 72 includes an l-shaped release tab 78 that is able to slightly flex and terminates with an angled and inwardly projecting notch 80. When the male and female plugs 68 and 72 are brought together the prongs 70 seat within the apertures 74 concomitant with the release tab 78 slightly flexing and sliding upon the locking tab 74 so that the notch 80 catches the inwardly beveled surface 82 of the locking tab 76 thereby locking the male and female plugs 68 and 72 together. In order to unlock and detach the plugs 68 and 72 as part of the process of detaching the bulb and shade assembly 36 from the stake 16, the individual would manually lift up on the notch 80 thereby disengaging the release tab 78 from the locking tab 76 and allowing the detachment and separation of the male and female plugs 68 and 72 from each other.

It should be noted that solar panels can be incorporated with the shades such as shades 42 shown in FIGS. 1, 2 and 5, or the decorative (Halloween) shades 46 shown in FIG. 10 whereby each shade 42 or 46 would include a small-size solar panel 84 mounted on the respective shade 42 or 46 and integrated and electrically interconnected with the lighting system 10. The lighting fixtures 14 would be placed about the walkway, sidewalk or driveway so as to maximize the amount of sunlight striking the solar panels 84, and the solar panels 84 would function as collectors of the sun's thermal energy that, in turn, is converted into energy for illuminating the bulbs 40.

FIGS. 11 and 12 illustrate embodiments that provide energy for illuminating the bulbs 40 of the lighting system 10 from alternative sources. Thus, FIG. 11 illustrates a battery 86 connected to the lighting system 10, and the battery 86 connected to a battery-recharging unit 88. The recharging unit 88 includes an electrical cord 90 and plug 92 with the plug 92 capable of being plugged into a standard electrical outlet or receptacle (not shown). The battery 86 can be of various capacities and voltages for illuminating the bulbs 40 for a given time period that upon the diminishment or expiration of the battery charge will necessitate recharging of the battery 86 by recharging unit. 88. FIG. 12 illustrates a solar panel 94 receiving radiant energy from the sun 95, and preferably mountable to a house, garage or shed roof and which is electrically connected to a battery 96. The battery 96 in turn is connected to and provides DC current to the lighting system 10 for illuminating the bulbs 40 of the lighting system 10. The electrical cord 98 would be of sufficient length to allow for the roof mounting of the solar panels 94 and their electrical connection to the battery 96 so that the battery 96 can be located in a safe, protected and convenient place and the connection to the lighting system 10 can also be in a safe and convenient manner. It should also be noted that the charging systems shown in FIGS. 11 and 12 can be integrated whereby the batteries 86 and 96 are initially charged, and then the charge is maintained by the use of the solar panels 94.

The foregoing is considered as illustrative of several embodiments of the invention, and since numerous alterations, modifications, and variations are possible and practicable to those skilled in the art, it is not desired to limit the invention to the exact construction and operation shown and described, but to any suitable modifications, alterations, and variations falling within the spirit of the invention and the scope of the appended claims.

I claim:

1. A decorative outdoor lighting system, comprising:
a plurality of lighting fixtures removably insertable into a ground surface at regularly spaced intervals and in electrical interconnection with each other;
each lighting fixture including a lower tapered end for insertion into the ground surface and an opposed upper end, a continuous sidewall, and a hollow interior enclosed by the sidewall and extending from the lower end to the upper end;
an interchangeable bulb and shade assembly capable of attachment to and detachment from the stake;
the bulb and shade assembly including a bulb, a shade, a stem and the stem including a base that is capable of attachment to and detachment from the upper end of the stake so that the bulb and shade assembly can be attached to and detached from the stake;
the shade being interchangeable on the stem and configured to have a form or shape that is representative of a specific event, holiday occasion or season;
a coupling assembly for locking engagement and disengagement of the stem to the upper end of the stake, the coupling assembly including a plurality of inwardly projecting protrusions mounted to the upper end of the stake, an enlarged circular head located at the base of the stem and having four spaced-apart semi-circular ledges defining four slots with the slots being disposed at 90 degrees from each other; and
the slots being slidably mateable with the protrusions so that the semi-circular ledges can be disposed within the upper end and whereupon a one quarter rotation of the stem causes each semi-circular ledge to be positioned under each corresponding protrusion thereby locking the bulb and shade assembly to the stake with another one quarter rotation aligning the slots with the protrusions so that the base of the stem can be lifted up past the protrusions for detaching the bulb and shade assembly from the stake.

2. The decorative outdoor lighting system of claim 1 further comprising a pair of quick connect/disconnect plugs with one plug mounted to the base of stem and the other plug disposed within the upper end of the stake with the plugs brought into engagement for completely the electrical circuit and resulting in the illumination of the bulb.

3. The decorative outdoor lighting system of claim 2 wherein the stem includes an annular neck adjacent the enlarged circular head and having a smaller diameter than the stem and the enlarged circular head so that the neck can be disposed adjacent the protrusions when the bulb and shade assembly is locked to the upper end of the stake.

4. The decorative outdoor lighting system of claim 3 further comprising a battery electrically connected to the lighting fixtures for illuminating the bulbs included in all the bulb and shade assemblies.

5. The decorative outdoor lighting system of claim 4 further comprising a recharging unit for recharging the battery and the recharging unit including an electrical plug for plugging into a standard electrical outlet or receptacle.

6. The decorative outdoor lighting system of claim 5 further comprising a solar panel in electrical connection with the battery for energizing the battery so that the battery can illuminate the bulbs of the lighting fixtures.

7. A decorative outdoor lighting system for placement adjacent to a sidewalk or a driveway for illumination thereof, comprising
a plurality of lighting fixtures for removable insertion into a ground surface at regularly spaced intervals and in electrical interconnection with each other;
each lighting fixture including a lower tapered end for insertion into the ground surface and an opposed upper end, and a hollow interior extending from the lower end to the upper end;
an interchangeable bulb and shade assembly capable of attachment to and detachment from the stake;
the bulb and shade assembly including a bulb, a shade, a stem and the stem including a base that is attachable to the upper end of the stake so that the bulb and shade assembly can be attached to and detached from the stake;
the shade that is configured in a shape that is representative of a particular holiday, season or occasion;
a coupling assembly for locking the stem to, and for unlocking the stem from, the upper end, the coupling assembly including at least for inwardly projecting protrusions mounted at the upper end, an enlarged circular head located at the base of the stem, at least four spaced-apart semi-circular ledges further defining at least four slots with the slots located between the ledges and the slots disposed at 90 degrees from each other;
the slots being slidably mateable with the protrusions so that the semi-circular ledges can be slide past the protrusions for disposition within the upper end and whereupon a one quarter rotation of the stem causes each semi-circular ledge to be positioned under each respective protrusion thereby locking the bulb and shade assembly to the stake; and
a pair of quick connect/disconnect plugs with one plug projecting from the base of the stem and one plug mounted to the upper end of the stake so that the plugs are connected during the locking of the stem to the stake thereby providing for the electrical connection to the bulb for illuminating the bulb.

8. The decorative outdoor lighting system of claim 7 wherein the stem includes an annular neck adjacent and inboard of the base of the stem and having a smaller diameter than the stem and the enlarged circular head of the stem so that the neck can slide past the protrusions to facilitate the attachment and detachment of the bulb and shade assembly to the upper end of the stake.

9. The decorative outdoor lighting system of claim 8 further comprising a battery electrically interconnected to the lighting fixtures for supplying the electrical power for illuminating the bulbs of the lighting fixtures.

9. The decorative outdoor lighting system of claim 8 further comprising a recharging unit for recharging the battery and the recharging unit including an electrical cord and an electrical plug with the electrical plug capable of being plugged into an electrical outlet or receptacle.

10. The decorative outdoor lighting system of claim 9 further comprising a solar panel in electrical interconnection with the battery for energizing the battery so that the battery can provide the electrical power to illuminate the bulbs of the lighting fixtures.

11. The decorative outdoor lighting system of claim 10 further comprising a plurality of small-size solar panels with each small-size solar panel mountable to the shade of each bulb and shade assembly for incorporation as the power source to illuminate the bulb for each respective bulb and shade assembly
